(19) United States
(12) Patent Application Publication
(10) Pub. No.: US 2006/0223399 A1
(43) Pub. Date: Oct. 5, 2006

(54) Rubber product with fiber reinforcing layer and method for producing the same

(75) Inventors: Hidekazu Kurimoto, Aichi-ken (JP); Hidenori Hayashi, Aichi-ken (JP); Takayuki Mohri, Aichi-ken (JP); Takeshi Funaki, Fukuoka-ken (JP); Yukio Imokawa, Fukuoka-ken (JP)

Correspondence Address: POSZ LAW GROUP, PLC, 12040 SOUTH LAKES DRIVE, SUITE 101, RESTON, VA, 20191, US

(73) Assignee: TOYODA GOSEI CO., LTD., Aichi-ken (JP)

(21) Appl. No.: 11/367,484

(22) Filed: Mar. 6, 2006

(30) Foreign Application Priority Data
Mar. 29, 2005 (JP) 2005-096060

(51) Int. Cl. B32B 27/02

(52) U.S. Cl. 442/164; 156/148

(57) ABSTRACT

The present invention provides a rubber product with a fiber reinforcing layer, which is enabled to bond a rubber layer and a fiber reinforcing layer by a formalin-free adhesive with an adhesive strength equal to or more than that of a formalin-containing RFL. The rubber product with the fiber reinforcing layer includes a rubber layer containing a nonpolar rubber or a diene-based rubber, and a fiber reinforcing layer containing a woven fiber cord having a polarity. The rubber layer and the fiber reinforcing layer are stacked and bonded with an adhesive containing a triazine thiol and a diene-based rubber.

### TECHNICAL FIELD

The present invention relates to a rubber product reinforced by a fiber reinforcing layer formed by weaving a fiber cord, such as a rubber hose, a tire, and a belt.

### BACKGROUND OF THE INVENTION

Fiber-rubber materials containing rubbers and organic fibers such as nylon fibers and polyester fibers have fatigue resistance sufficient for practical use, and thereby have widely been used for various rubber products such as hoses, tires, and belts. These fiber-rubber materials are such that a base material containing a rubber is reinforced by a cord which is obtained by applying an adhesive, etc. to a twisted fiber bundle. Though fiber-rubber materials using carbon fibers are excellent in dimensional stability, weather resistance, etc., they are poor in fatigue resistance because a carbon fiber cord is easily broken by abrasion between the single fibers and a rubber is easily peeled off the cord at the interface. On the other hand, a carbon fiber bundle impregnated with a resin composition, which comprises an epoxy resin and an RFL liquid containing a resorcin-formalin (RF) resin and a rubber latex, is commonly used because of strong bonding to a rubber.

In the case of using the RFL resin for bonding a reinforcing yarn layer to a rubber layer, the strong bonding between the layers can be achieved. However, formalin used for synthesizing the RFL is a VOC substance (a volatile organic compound) and is suspected to have allergenic potency and carcinogenicity. Therefore, a product free of formalin which does not cause such a problem has been demanded. Related patents on the formalin-free fiber-rubber material are as follows.

(1) Disclosed in JP-A-2004-150458 is a radiator hose comprising a rubber layer and a fiber reinforcing layer, which are bonded with a treatment liquid containing a component A of an end-modified (an epoxy group, an amino group, a vinyl group, or a carboxyl group) NBR, a component B of a 1.8-diazabicyclo (5.4.0) undecene-7 salt (a DBU salt, an adhesive for CHR, FKM, etc., a CHR promoter), and a component C of an organic solvent (such as MEK, methanol, toluene, isopropyl alcohol, methyl cellosolve acetate, and dimethylformamide).

(2) Disclosed in JP-A-2004-150459 is a radiator hose comprising a rubber layer and a fiber reinforcing layer, which are bonded with a treatment liquid containing a maleic acid polymer, a 18-diazabicyclo(5.4.0)undecene-7 salt (a DBU salt), and an organic solvent (such as MEK, methanol, toluene, isopropyl alcohol, methyl cellosolve acetate, and dimethylformamide). The component ratio is equal to that of JP-A-2004-150458.

(3) Disclosed in JP-A-2004-150460 is a radiator hose comprising a rubber layer and a fiber reinforcing layer, which are bonded with a treatment liquid containing a component A of an epoxy resin, a component B of a silane coupling agent, and a component C of an organic solvent (such as MEK, methanol, toluene, isopropyl alcohol, methyl cellosolve acetate, and dimethylformamide), a lipophilic polymer being preferably added thereto.

(4) Disclosed in JP-A-11-100561 is a composite body comprising a rubber layer and a fiber reinforcing layer, which are bonded with a latex adhesive using nitroalcohol instead of formalin as a methylene donor for an initial resorcin-formalin condensation product. This adhesive is an RFL capable of reducing formaldehyde without deteriorating bonding between the fiber and the rubber.

(5) Disclosed in JP-A-11-280954 is a reinforced hose comprising a rubber layer and a fiber reinforcing layer, which are bonded with an adhesion activator of a triazine thiol compound.

### SUMMARY OF THE INVENTION

The adhesives other than triazine used in JP-A-2004-150458, JP-A-2004-150459, and JP-A-2004-150460 are poor in bonding strength, and thereby it can be applied only to certain hoses.

In JP-A-11-100561, nitroalcohol is used instead of formalin in the RFL, so that disadvantageously the condensation reaction with the resorcin resin is not likely to proceed.

In JP-A-11-280954, NBR, NR, SBR, CR, ACM, and FKM are shown as examples of materials for the rubber layer, and NBR/BR, NR, and SBR/CR are used in Examples. As a result of further examination in these rubbers by the inventors, in the cases of using nonpolar rubbers (NR and SBR) and diene-based rubbers (NR, SBR, and NBR), the fiber reinforcing layer could not be bonded with a sufficient bonding strength only by a triazine thiol.

It should be noted that, though many papers and patent applications have reported methods of bonding metals such as brass with triazine, techniques for bonding an inactive polyester thread to a nonpolar rubber such as EPDM with triazine have not been established. Bonding between the EPDM and the polyester thread treated with triazine or a combination of epoxy and triazine is very weak, and thereby it cannot be applied to hoses, etc. The EPDM is excellent in resistance to weather, heat, and liquids and has been widely used in belts, cooling hoses, brake hoses, etc., whereby the bonding between a formalin-free-treated thread and the EPDM has been demanded.

An object of the present invention is to solve the above problems and to provide a rubber product with a fiber reinforcing layer, which is enabled to bond a rubber layer and a fiber reinforcing layer by a formalin-free adhesive with an adhesive strength equal to or more than that of a formalin-containing RFL, and a method for producing the same.

In order to solve the aforementioned problems, the invention includes the following features.

(1) A rubber product with a fiber reinforcing layer which comprises a rubber layer comprising a nonpolar rubber or a diene-based rubber; and a fiber reinforcing layer comprising a woven fiber cord, the fiber cord being one of a fiber cord having a polarity in a material and a fiber cord being subjected to a polarizing treatment to have a polarity, wherein the rubber layer and the fiber reinforcing layer are stacked and bonded with an adhesive comprising a triazine thiol and a diene-based rubber.

(2) A method for producing a rubber product with a fiber reinforcing layer which comprises a fiber stacking step of stacking a fiber reinforcing layer comprising a woven fiber cord on an unvulcanized rubber layer comprising a nonpolar rubber or a diene-based rubber, the fiber cord being one of a fiber cord having a polarity in a material and a fiber cord being subjected to a polarizing treatment to have a polarity, an adhesive treatment step of applying an adhesive solution comprising a triazine thiol and a diene-based rubber dissolved in a solvent to at least an interface between the rubber layer and the fiber reinforcing layer, and a drying step of drying the resultant stack at 50 to 180° C. while pressing the fiber reinforcing layer against the rubber layer.

(3) A method for producing a rubber product with a fiber reinforcing layer which comprises an adhesive treatment step of applying an adhesive solution comprising a triazine thiol and a diene-based rubber dissolved in a solvent to a fiber cord, the fiber cord being one of a fiber cord having a polarity in a material and a fiber cord being subjected to a polarizing treatment to have a polarity, a drying step of drying the fiber cord at 50 to 180° C., and a fiber stacking step of stacking a fiber reinforcing layer formed by weaving the fiber cord after the drying step on an unvulcanized rubber layer comprising a nonpolar rubber or a diene-based rubber.

Embodiments of the above features are described below.

[Rubber Layer]

The nonpolar rubber for the rubber layer is not particularly limited, and examples thereof include NR (natural rubbers), SBR (styrene-butadiene rubbers), BR (butadiene rubbers), EPDM (ethylene-propylene-diene copolymers), and IIR (isobutylene-isoprene copolymers).

The diene-based rubber for the rubber layer is not particularly limited, and examples thereof include NR, SBR, BR, NBR, and CR (chloroprene rubbers).

Thus, it is preferred that the nonpolar rubber or the diene-based rubber of the rubber layer is one, two, or more selected from the group consisting of NR, SBR, BR, EPDM, IIR, NBR, and CR.

Incidentally, when plural rubber layers are stacked, each rubber layer may individually employ either of the nonpolar rubber or the diene-based rubber. All of rubber layers may be the same kind of materials or may be different.

[Fiber Cord]

Though a twisted thread cord made of various fibers may be used, the fiber cord has a polarity in the material, or alternatively the fiber cord is such that a cord not having a polarity in the material is subjected to a polarizing treatment to have the polarity.

The fiber cord having a polarity in the material is not particularly limited, and examples of the materials include polyamides, aramids, rayons, and vinylons.

The fiber cord not having a polarity in the material is not particularly limited, and examples of the materials include polyesters. The cord is subjected to the polarizing treatment to have the polarity. The polarizing treatment is not particularly limited, and epoxy treatments (including isocyanate) may be exemplified.

The mode of weaving the fiber cord is not particularly limited, and for example the fiber cord may be woven in a braid or spiral form.

Incidentally, when plural fiber reinforcing layers are stacked, each fiber reinforcing layer may individually employ either of the fiber cord having a polarity in the material or the fiber cord being subjected to a polarizing treatment to have the polarity. All of fiber cords may be the same kind of materials or may be different.

[Adhesive and Adhesive Solution]

Examples of the triazine thiols for the adhesive include 2-butylamino-4,6-dimercapto-s-triazine.

Examples of the diene-based rubbers for the adhesive include NR, SBR, BR, NBR, CR, and BR is preferably used.

The component ratio of the triazine thiol/the diene-based rubber is 1/9 to 9/1, and preferably 1/5 to 5/1.

Examples of the solvents for the adhesive solution include MEK (methyl ethyl ketone) and toluene.

In the adhesive solution, the triazine thiol content and the diene-based rubber content are not particularly limited and preferably satisfy the following three conditions:

(a) the component ratio of the triazine thiol/the diene-based rubber is 1/9 to 9/1;

(b) the triazine thiol content is 1% by mass or more; and

(c) the total content of the triazine thiol and the diene-based rubber is 1 to 10% by mass, it being more preferred that the total content is 1 to 5% by mass from the viewpoint of preventing wastes of adhesives and bonding defects of the fiber cord in a second production method to be hereinafter described.

According to the rubber product with the fiber reinforcing layer and the method for producing the same of the invention, the rubber layer and the fiber reinforcing layer can be bonded by the formalin-free adhesive with an adhesive strength equal to or more than those of formalin-containing RFLs to obtain a formalin-free product. Thus, there is attained an excellent advantage that good adhesion between the rubber layer and the fiber reinforcing layer can be obtained with formalin-free materials.

### BRIEF DESCRIPTION OF DRAWINGS

FIGS. 1A and 1B are an end-broken perspective view and a half sectional view showing a rubber hose with a fiber reinforcing layer according to the present invention;

FIG. 2 is an explanatory view showing a first method for producing the rubber hose with the fiber reinforcing layer; and

FIG. 3 is an explanatory view showing a second method for producing the rubber hose with the fiber reinforcing layer.

### DETAILED DESCRIPTION OF THE INVENTION

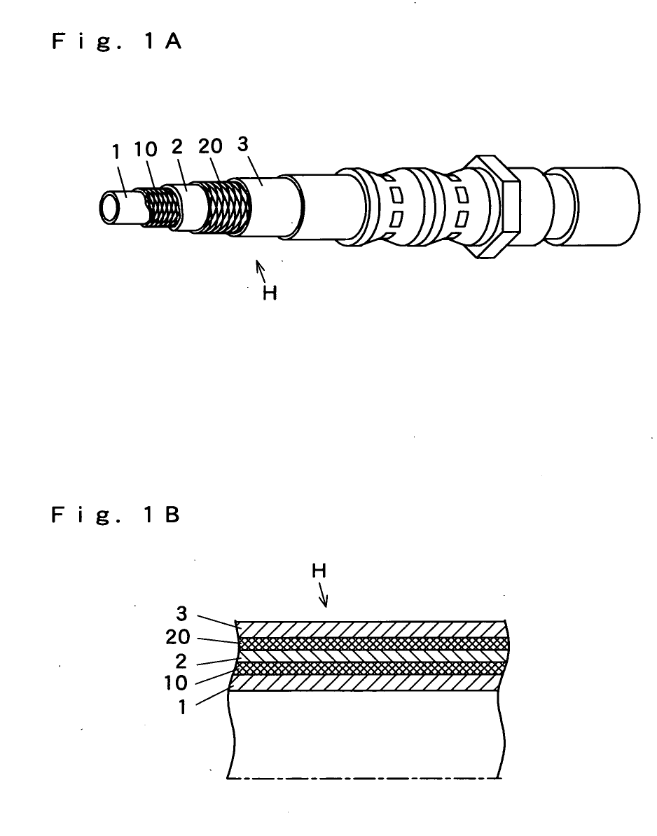

FIG. 1 shows a rubber hose H with a fiber reinforcing layer according to an embodiment of the present invention.

The rubber hose H with the fiber reinforcing layer comprises an inner rubber tube 1, a first fiber reinforcing layer 10, an intermediate rubber layer 2, a second fiber reinforcing layer 20, and a rubber skin 3, which are bonded in this order from inside to outside. For example, the inner rubber tube 1, the intermediate rubber layer 2, and the rubber skin 3 are composed of an EPDM. The first fiber reinforcing layer 10 and the second fiber reinforcing layer 20 may be such that a twisted thread cord of a polyester fiber not having a polarity in the material is subjected to an epoxy treatment to be made polar, and the obtained fiber cords 11, 21 are woven in a braid or spiral form around an outer circumference of the inner rubber tube 1 and the intermediate rubber layer 2, respectively. Further, the second fiber reinforcing layer 20 is bonded to each of the intermediate rubber layer 2 and the rubber skin 3 with an adhesive comprising a triazine thiol and a diene-based rubber.

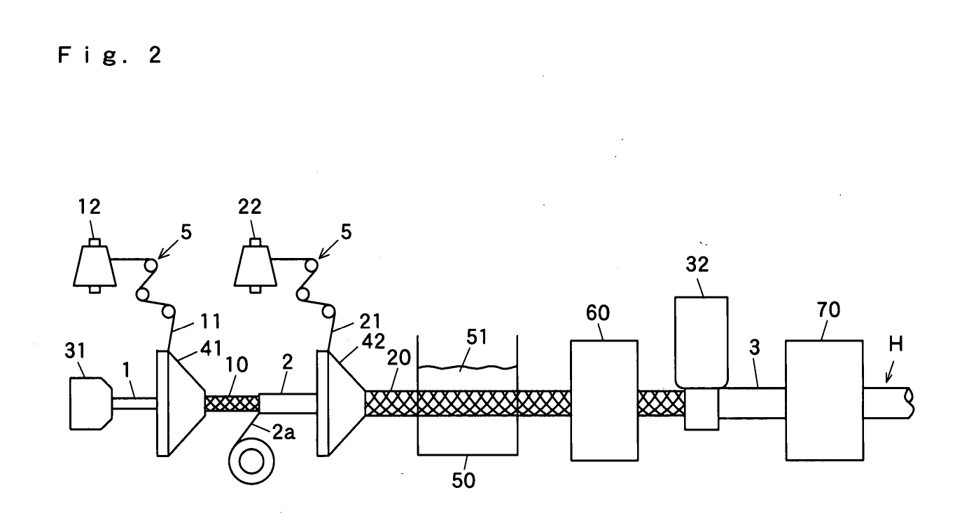

FIG. 2 shows a first method of producing the rubber hose H with the fiber reinforcing layer.

(1) Inner rubber tube forming step: The inner rubber tube 1 is continuously extrusion-molded by a first extruder 31. A mandrel (not shown) is inside the extruded, unvulcanized inner rubber tube 1.

(2) First fiber stacking step: The fiber cord 11 wound on a bobbin 12 is unwounded, guided by a thread guide unit 5, and transferred to a first weaving apparatus 41. Then, the fiber cord 11 is woven around the outer circumference of the inner rubber tube 1 in a braid or spiral form by the first weaving apparatus 41 to stack the first fiber reinforcing layer 10.

(3) Intermediate rubber layer forming step: A rubber sheet 2a is wound on the outer circumference of the first fiber reinforcing layer 10 to form a coating of the intermediate rubber layer 2.

(4) Second fiber stacking step: The fiber cord 21 wound on a bobbin 22 is unwounded, guided by a thread guide unit 5, and transferred to a second weaving apparatus 42. Then, the fiber cord 21 is woven around the outer circumference of the intermediate rubber layer 2 in a braid or spiral form to stack the second fiber reinforcing layer 20. The second fiber reinforcing layer 20 is appropriately pressed against the outer circumference of the intermediate rubber layer 2 by cord tension in this weaving process.

(5) Adhesive treatment step: The stack of the inner rubber tube 1 to the second fiber reinforcing layer 20 is passed through an adhesive solution 51 in a bath 50, which is obtained by dissolving a triazine thiol and a diene-based rubber in a solvent, whereby the adhesive solution is applied to the outside surface of the second fiber reinforcing layer 20 and an interface between the second fiber reinforcing layer 20 and the intermediate rubber layer 2.

(6) Drying step: The stack of the inner rubber tube 1 to the second fiber reinforcing layer 20 is passed through a drying apparatus 60, and dried at 50 to 180° C. for 50 to 240 seconds while pressing the second fiber reinforcing layer 20 against the intermediate rubber layer 2, whereby (a) the solvent in the adhesive solution 51 is completely evaporated, and (b) the adhesive of the triazine thiol and the diene-based rubber is reacted with the intermediate rubber layer 2 and the second fiber reinforcing layer 20.

(7) Rubber skin forming step: A coating of the rubber skin 3 is formed on the outer circumference of the second fiber reinforcing layer 20 by a second extruder 32. As a result, the second fiber reinforcing layer 20 is appropriately pressed also against the rubber skin 3, and the adhesive is applied also to an interface between the second fiber reinforcing layer 20 and the rubber skin 3.

(8) Vulcanization step: After the rubber skin forming step, the stack is heated at 145 to 165° C. for 15 to 30 minutes by a vulcanization apparatus 70, so that the inner rubber tube 1, the intermediate rubber layer 2, and the rubber skin 3 is vulcanized, and the adhesive is reacted with the rubber skin 3. The rubber hose H with fiber reinforcing layer is produced by aforementioned steps.

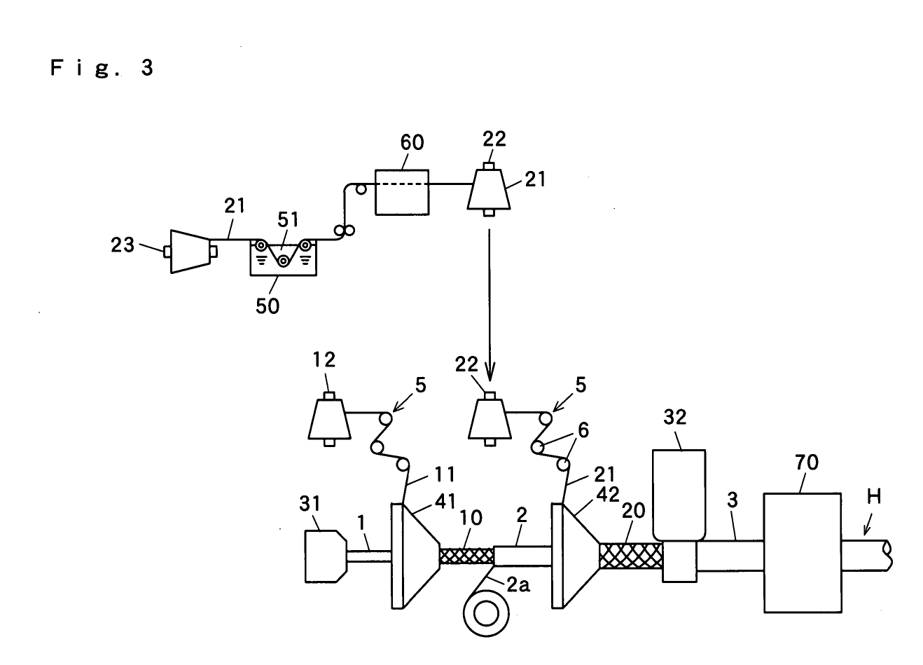

FIG. 3 shows a second method for producing the rubber hose H with fiber reinforcing layer.

(1) Adhesive treatment step: The fiber cord 21 wound on a bobbin 23 is unwounded and passed through an adhesive solution 51 in a bath 50, which is prepared by dissolving a triazine thiol and a diene-based rubber in a solvent, to apply the adhesive solution 51 to the fiber cord 21.

(2) Drying step: The fiber cord 21 is passed though the drying apparatus 60 and dried at 50 to 180° C. for 50 to 240 seconds, whereby (a) the solvent of the adhesive solution 51 is completely evaporated and (b) the fiber cord 21 is reacted with the adhesive of the triazine thiol and the diene-based rubber. The fiber cord 21 after drying step is wound on a bobbin 22.

(3) Inner rubber tube forming step: The inner rubber tube 1 is continuously extrusion-molded by a first extruder 31. A mandrel (not shown) is inside the extruded, unvulcanized inner rubber tube 1.

(4) First fiber stacking step: The fiber cord 11 wound on a bobbin 12 is unwounded, guided by a thread guide unit 5, and transferred to a first weaving apparatus 41. Then, the fiber cord 11 is woven around the outer circumference of the inner rubber tube 1 in a braid or spiral form by the first weaving apparatus 41 to stack the first fiber reinforcing layer 10.

(5) Intermediate rubber layer forming step: A rubber sheet 2a is wound on the outer circumference of the first fiber reinforcing layer 10 to form a coating of the intermediate rubber layer 2.

(6) Cord transfer step and second fiber stacking step: The fiber cord 21 wound on the bobbin 22 after the drying step is unwounded, guided by a thread guide unit 5, and transferred to a second weaving apparatus 42. Then, the fiber cord 21 is woven around the outer circumference of the intermediate rubber layer 2 in a braid or spiral form to stack the second fiber reinforcing layer 20. At this time, the fiber cord 21 is passed through pulleys 6, a roller, a shaft, etc. in the thread guide unit 5. However, since the adhesive and the fiber of the fiber cord 21 treated with the adhesive are not likely to be peeled off during the transfer, it is rare that a bonding defect and dirt are generated. Thus, adhesion of dirt to the product and facility deterioration due to dirt deposition are less likely to be caused. Further, since the fiber cord 21 is stable and has a low friction coefficient, the fiber cord 21 can smoothly pass through the thread guide unit 5, and the second fiber reinforcing layer 20 can have a constant dimension without tension variation of the fiber cord 21. The second fiber reinforcing layer 20 is appropriately pressed against the outer circumference of the intermediate rubber layer 2 by the cord tension in the weaving process.

(7) Rubber skin forming step: A coating of the rubber skin 3 is formed on the outer circumference of the second fiber reinforcing layer 20 by a second extruder 32. As a result, the second fiber reinforcing layer 20 is appropriately pressed also against the rubber skin 3, and the adhesive is applied also to an interface between the second fiber reinforcing layer 20 and the rubber skin 3.

(8) Vulcanization step: After the rubber skin forming step, the stack is heated at 145 to 165° C. for 15 to 30 minutes by a vulcanization apparatus 70, so that the inner rubber tube 1, the intermediate rubber layer 2, and the rubber skin 3 are vulcanized, and the adhesive is reacted with the inner rubber tube 1, the intermediate rubber layer 2, and the rubber skin 3. The rubber hose H with fiber reinforcing layer is produced by aforementioned steps.

### EXAMPLES

Test pieces of Examples and Comparative Examples were each produced in the following manner.

1. An unvulcanized rubber plate of 150 mm×150 mm×2 mm (thickness) in size was prepared from an EPDM.

2. A twisted thread cord of a polyester fiber was made polar by an epoxy treatment to prepare a fiber cord. The fiber cord was composed of 200 to 400 filaments bundled.

3. An adhesive solution was prepared by mixing the following components. The details of the components are shown in Table 1. It should be noted that an RFL liquid was used as an adhesive solution in Comparative Example 1.

A triazine thiol of 2-butylamino-4,6-dimercapto-s-triazine (TDT): 1 to 7% by mass

A diene-based rubber of 1,2BR: 0 to 4% by mass

Solvents of methyl ethyl ketone (MEK) and toluene: the balance

4. The adhesive solution was applied to the twisted thread cord, and the twisted thread cord was wound 7 revolutions at intervals of 2 mm around a frame mold. The frame mold was fit into a plate lower die, the unvulcanized rubber plate was placed on the lower die and the twisted thread cord, and further an upper die was placed thereon. The resultant was pressed by a pressing apparatus and heated at 160° C. for 15 minutes, whereby the rubber plate was vulcanized and the adhesive was reacted with the fiber cord and the rubber plate.

A 180 degree peeling test was carried out such that the rubber plate was cut into a strip containing 7 fiber cords, a cut was made in the strip in the longitudinal direction, and the ends in the longitudinal direction were held in a couple of chucks of a tensile tester and pulled at a rate of 50 mm/minute. The maximum adhesive strength observed before peeling occurred and the peeling mode for a position of the peeling were examined. The results are shown in Table 1.

TABLE 1

| | | Adhesion | | |
|---|---|---|---|---|
| | | Adhesive | | |
| | TDT/1,2BR | Strength | Peeling | |
| | (wt %) | (N/7 pieces) | Mode | Judgment |
| Example 1 | 2.5/2.5 | 11.9 | Base | ◯ |
| Example 2 | 4/1 | 8.5 | Base | ◯ |
| Example 3 | 1.5/1.5 | 10.5 | Base | ◯ |
| Example 4 | 1/4 | 10.6 | Base | ◯ |
| Comparative | — | 8.0 | Base | ◯ |
| Example 1 (RFL) | | | | |
| Comparative | 5/0 | 6.2 | Interface | X |
| Example 2 | | | | |
| Comparative | 7/0 | 5.7 | Interface | X |
| Example 3 | | | | |

In Comparative Example 1, the conventional RFL was used as the adhesive, so that the test piece had a sufficient adhesive strength, but it disadvantageously contained formalin as mentioned above. In Comparative Examples 2 and 3, only the triazine thiol was used as the adhesive, so that the test pieces were poor in adhesive strength, and thus peeling was caused at the interface between the rubber plate and the fiber cord. On the other hand, in Examples 1 to 4, the mixtures of the triazine thiol and the 1,2BR were used as the adhesives, so that the test pieces exhibited adhesive strengths higher than that of Comparative Examples 1 (RFL), and peeling was caused in the base rubber plate. It was clear from Examples 1 to 4 that, by using the formalin-free adhesives, the rubber layer and the fiber reinforcing layer could be bonded with adhesive strengths equal to or more than that of the formalin-containing RFL.

Incidentally, the invention is not limited to the forgoing examples, and various modifications such as the following ones may be made without departing from the scope of the invention.

(1) The rubber hose may have a three-layered structure of an inner tube, a fiber reinforcing layer, and a skin. Further, the number of layers in the rubber hose may be 3, 5, or the other numbers.

(2) The rubber product of the invention may be a product such as a tire and a belt other than the rubber hose.

What is claimed is:

1. A rubber product with a fiber reinforcing layer comprising:
a rubber layer comprising at least one selected from the group consisting of a nonpolar rubber and a diene-based rubber; and
a fiber reinforcing layer comprising a woven fiber cord, the fiber cord being one of a fiber cord having a polarity in a material and a fiber cord being subjected to a polarizing treatment to have a polarity,
wherein the rubber layer and the fiber reinforcing layer are stacked and bonded with an adhesive comprising a triazine thiol and a diene-based rubber.

2. The rubber product with the fiber reinforcing layer according to claim 1, wherein the nonpolar rubber or the diene-based rubber of the rubber layer comprises at least one selected from the group consisting of NR, SBR, BR, EPDM, IIR, NBR, and CR.

3. The rubber product with the fiber reinforcing layer according to claim 1, wherein the fiber cord having the polarity in the material comprises at least one of fibers selected from the group consisting of polyamides, aramids, rayons, and vinylons.

4. The rubber product with the fiber reinforcing layer according to claim 1, wherein the polarizing treatment is an epoxy treatment.

5. The rubber product with the fiber reinforcing layer according to claim 1, wherein the diene-based rubber of the adhesive comprises at least one selected from the group consisting of NR, SBR, BR, NBR, and CR.

6. The rubber product with the fiber reinforcing layer according to claim 1, wherein a component ratio of the triazine thiol/the diene-based rubber of the adhesive is 1/9 to 9/1.

7. A method for producing a rubber product with a fiber reinforcing layer comprising:
a fiber stacking step of stacking a fiber reinforcing layer comprising a woven fiber cord on an unvulcanized rubber layer comprising at least one selected from the group consisting of a nonpolar rubber and a diene-based rubber, the fiber cord being one of a fiber cord having a polarity in a material and a fiber cord being subjected to a polarizing treatment to have a polarity,
an adhesive treatment step of applying an adhesive solution comprising a triazine thiol and a diene-based rubber dissolved in a solvent to at least an interface between the rubber layer and the fiber reinforcing layer, and
a drying step of drying the resultant stack at 50 to 180° C. while pressing the fiber reinforcing layer against the rubber layer.

8. The method for producing a rubber product with a reinforcing layer according to claim 7, wherein the diene-based rubber of the adhesive solution comprises at least one selected from the group consisting of NR, SBR, BR, NBR, and CR.

9. The method for producing a rubber product with a reinforcing layer according to claim 7, wherein, in the adhesive solution, a content of the triazine thiol and the diene-based rubber satisfy the following three conditions:
(a) the component ratio of the triazine thiol/the diene-based rubber is 1/9 to 9/1;
(b) the content of the triazine thiol is 1% by mass or more; and
(c) the total content of the triazine thiol and the diene-based rubber is 1 to 10% by mass.

10. A method for producing a rubber product with a fiber reinforcing layer comprising:
an adhesive treatment step of applying an adhesive solution comprising a triazine thiol and a diene-based rubber dissolved in a solvent to a fiber cord, the fiber cord being one of a fiber cord having a polarity in a material and a fiber cord being subjected to a polarizing treatment to have a polarity,
a drying step of drying the fiber cord at 50 to 180° C., and
a fiber stacking step of stacking a fiber reinforcing layer formed by weaving the fiber cord after the drying step on an unvulcanized rubber layer comprising at least one selected from the group consisting of a nonpolar rubber and a diene-based rubber.

11. The method for producing a rubber product with a reinforcing layer according to claim 10, wherein the diene-based rubber of the adhesive solution comprises at least one selected from the group consisting of NR, SBR, BR, NBR, and CR.

12. The method for producing a rubber product with a reinforcing layer according to claim 10, wherein, in the adhesive solution, a content of the triazine thiol and the diene-based rubber satisfy the following three conditions:
(a) the component ratio of the triazine thiol/the diene-based rubber is 1/9 to 9/1;
(b) the content of the triazine thiol is 1% by mass or more; and
(c) the total content of the triazine thiol and the diene-based rubber is 1 to 10% by mass.
